(19) United States
(12) Patent Application Publication
(10) Pub. No.: US 2015/0300625 A1
(43) Pub. Date: Oct. 22, 2015

(54) WATER RESISTANT LED-BASED DECORATIVE LIGHT ASSEMBLY

(71) Applicant: Fanatic Lights, LLC, Tampa, FL (US)

(72) Inventors: Nathaniel F. Land, Tampa, FL (US); Sangita A. Land, Tampa, FL (US)

(21) Appl. No.: 14/686,806

(22) Filed: Apr. 15, 2015

Related U.S. Application Data
(60) Provisional application No. 61/980,354, filed on Apr. 16, 2014.

(51) Int. Cl. F21V 31/00; F21V 23/00; F21V 3/04; F21V 23/02; F21V 23/04; F21S 4/00

(52) U.S. Cl. CPC F21V 31/005; F21V 23/04; F21S 4/001; F21V 3/04; F21V 23/023; F21V 23/001; F21Y 2103/003

(57) ABSTRACT

A decorative light assembly comprises a receptacle having a receptacle opening for receiving an LED, an LED cover having a cavity shaped to receive the LED, the LED cover having a stem configured to receive the LED into the cavity of the LED cover, and to extend into the receptacle opening of the receptacle to form a water resistant seal with the receptacle opening, a holder for retaining the receptacle and for electrical connection with the LED, and a waterproof battery pack for powering the light assembly.

### CROSS REFERENCE

This application claims the benefit of the U.S. Provisional Application No. 61/980,354, filed Apr. 16, 2014.

### FIELD OF INVENTION

The present invention relates to LED-based decorative light assemblies, and more particularly, to decorative light assembly that includes a LED cover press-fit into the LED holder to form a water resistant seal around the LED.

### BACKGROUND OF THE INVENTION

Decorative lights such as the familiar Christmas lights typically employ incandescent light bulbs and are connected along a strand. Consumers enjoy decorating their trees and surroundings, both indoor and outdoor, to achieve their desired effect. However, these incandescent lights, especially when multiple strands of lights are connected, give off relatively high heat and are fragile to handle when unprotected. It is especially challenging for manufacturers to design Christmas lights that are resistant to weather when the intended environment is outdoor. For example, rainwater can short the Christmas light circuitry and unintentional physical force exerted on the light bulbs can crack these light bulbs. Exposed light bulbs would also have reduced life when the rainwater contacting the light bulbs repeatedly causing sudden cool off of the light bulbs imparting extreme temperature cycling to the light bulbs.

Light Emitting Diodes (LEDs) consume very low power and thus operate at much lower temperature than incandescent light bulbs. This lower operating temperature gives rise to higher reliability due to smaller temperature cycling. However, they remain vulnerable to the weather when employed outdoor or exposed to adverse environmental conditions.

Heretofore, there is no decorative light assembly that is portable, water and shock resistant, and which allows consumers to easily utilize a variety of covers over the lights so as to customize the colors and other desired lighting effect.

### SUMMARY OF THE INVENTION

An object of the invention is to provide an LED-based decorative light assembly that is resistant to adverse environmental effect on the light assembly.

Another object of the invention is to provide a portable decorative light assembly that includes a water-resistant battery power pack.

Another object of the invention is to provide a water resistant decorative light assembly comprising an LED cover with a stem dimensioned for press fit or snug into an LED receptacle that is in turn configured for press fit or snug fit into a holder.

According to one aspect of the invention, the LED cover is made of a compliant material such as, for example, polyethylene.

According to another aspect of the invention, the LEDs of the decorative light assembly are connected in parallel to the power source such that the disconnection or malfunction of one LED in the assembly does not affect the operation of the remaining LEDs of the assembly.

According to one embodiment, a decorative light assembly comprises a receptacle having a receptacle opening for receiving an LED, an LED cover having a cavity shaped to receive the LED, the LED cover having a stem configured to receive the LED into the cavity of the LED cover, and to extend into the receptacle opening of the receptacle to form a water resistant seal with the receptacle opening, and a receptacle holder for retaining the receptacle and for electrical connection with the LED.

In another embodiment, the LED covers are of different colors and have different refractive indexes.

In yet another embodiment, a decorative light assembly comprises:

a receptacle having a circumferential wall forming a receptacle opening and a longitudinal seat portion configured to retain a Light Emitting Diode (LED), the circumferential wall having an annular protrusion, the longitudinal seat portion having a first and a second conduits, each of the first and second conduits being dimensioned for receiving a cathode and an anode of the LED, respectively;

a light cover having a cavity, the light cover having a stem configured to receive the LED into the cavity of the light cover and to extend from the light cover and into the receptacle opening of the receptacle, the stem having a neck portion configured to form a water resistant seal with and retention by the annular protrusion on the circumferential wall of the receptacle and a cylindrical section dimensioned for press-fit engagement with the circumferential wall of the receptacle, the neck portion having a radial diameter smaller than a radial diameter of the cylindrical section of the stem; and

a holder having an inner wall forming an opening and a chamber, the holder providing electrical connections to a power source, the chamber being configured for receiving and securing the receptacle for electrical connection between the power source and the cathode and anode of the LED, the inner wall of the holder being dimensioned for press-fit engagement with an outside surface of the circumferential wall of the receptacle.

In still another embodiment, a portable water-resistant decorative light string, comprises:

a. two or more Light Emitting Diode s(LED), each LED having a cathode and an anode;

b. a receptacle having a circumferential wall forming a receptacle opening and a longitudinal seat portion configured to retain one of the two or more LEDs, the longitudinal seat portion having a first and a second conduits, each of the first and second conduits being dimensioned for receiving the cathode and the anode of the one of the two or more LEDs, respectively;

c. a light cover having a cavity, the light cover having a stem configured to receive the LED into the cavity of the light cover and to extend from the light cover and into the receptacle opening of the receptacle to form a water resistant seal with the circumferential wall of the receptacle;

d. a holder having an inner wall forming an opening and a chamber, the holder providing electrical connections to a power source, the chamber being configured for receiving and securing the receptacle for electrical connection between the power source and the cathode and anode of the one of the two or more LEDs, the inner wall of the holder being dimensioned for press-fit engagement with an outside surface of the circumferential wall of the receptacle; and

e. a direct current (D/C) battery pack connected to the cathodes and anodes of the two or more LEDs.

In still another embodiment, a light holder assembly, comprises:

a. a cylindrical receptacle having a circumferential wall forming a receptacle opening and a longitudinal seat portion configured to retain a Light Emitting Diode (LED), the longitudinal seat portion having a first and a second conduits, each of the first and second conduits being dimensioned for feeding a cathode lead wire and an anode lead wire of the LED through said first and second conduits, respectively, each of the cathode lead wire and the anode lead wire being bent upwardly against the longitudinal seat portion in a retained position;

b. a globular light cover having a cavity, the globular light cover having a stem having a cylindrical section configured to receive the LED into the cavity of the light cover and to extend from the globular light cover and into the receptacle opening of the cylindrical receptacle to form a water resistant seal with the circumferential wall of the receptacle; and

c. a cylindrical holder having an inner wall forming an open chamber, the cylindrical holder including electrical power leads to a power source, the chamber being configured for receiving and securing the receptacle for electrical connection between the electrical power leads and the cathode and anode leads of the LED, the inner wall of the cylindrical holder being dimensioned for press-fit engagement with an outside surface of the circumferential wall of the receptacle.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### DESCRIPTION OF THE DRAWINGS

In the drawings:

FIG. 1 is an exploded view of an embodiment of the decorative light assembly;

FIG. 2 is a cross-sectional view of the decorative light assembly of FIG. 1;

FIG. 3 is an isometric view of the decorative light assembly of FIG. 1 with its components assembled;

FIG. 4 is a cross-sectional view of the decorative light assembly of FIG. 3;

FIG. 5 is a perspective view of a water resistant battery pack for powering the decorative light assembly; and

FIG. 6 is a plan view of the bottom portion of the water resistant battery pack.

### DETAILED DESCRIPTION OF THE PRESENTLY PREFERRED EMBODIMENTS

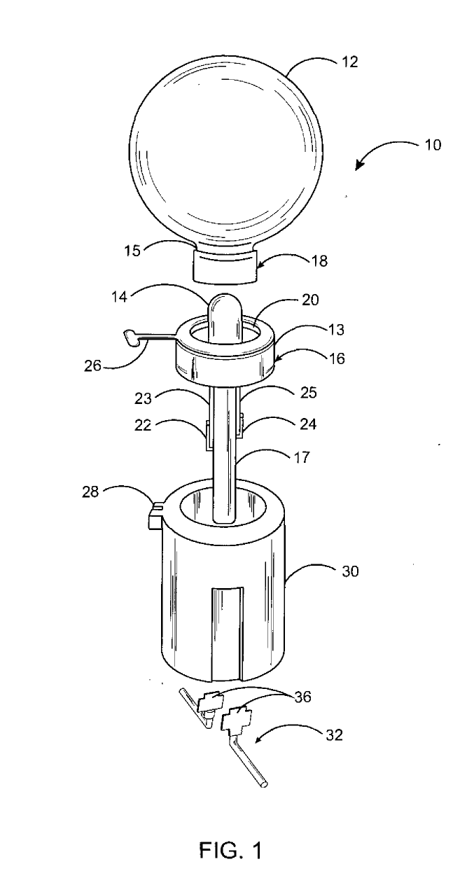

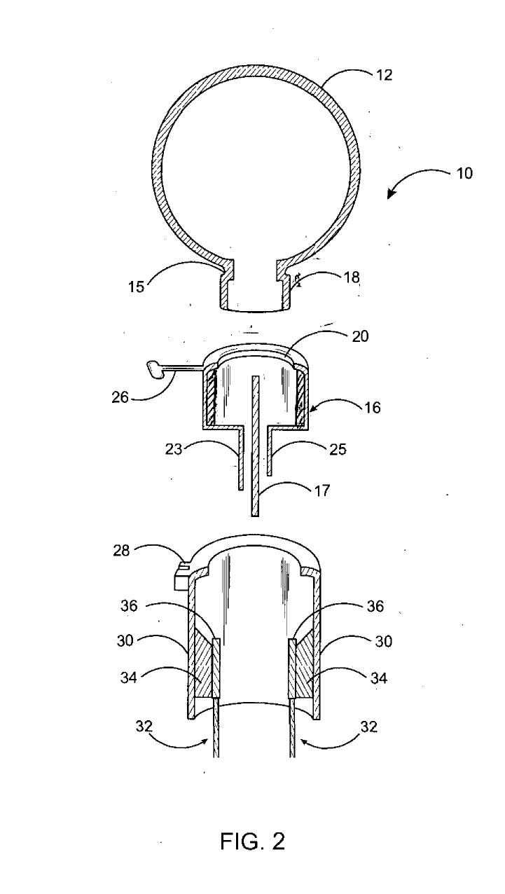

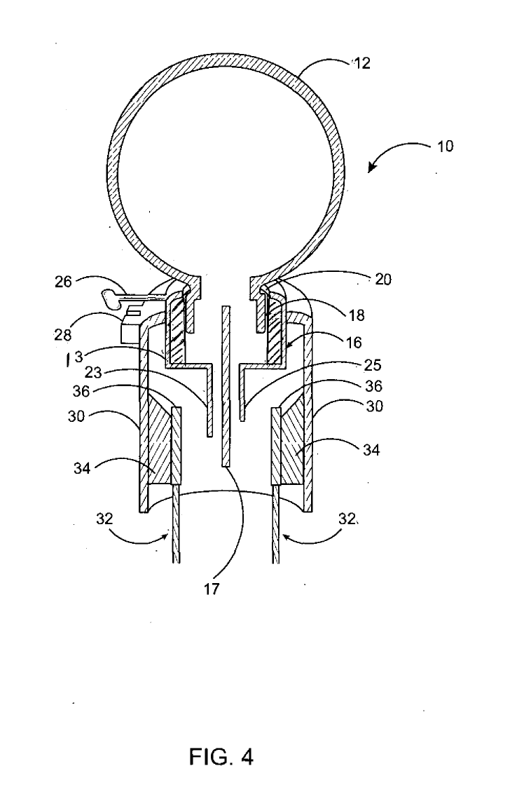

FIG. 1 is an exploded view of the presently preferred light assembly 10 in accordance with the present invention. As shown, there is provided a light cover 12, a Light Emitting Diode (LED) 14, a receptacle 16 having a collar 13 and an LED seat 17 for receiving and securing the LED 14, and a holder 30 defining a cavity for receiving and retaining the receptacle and for connecting the LED to a power source. The light cover 12 is preferably made of a translucent and compliant or elastic material and yet has a wide color range for customizable lighting effect. The material is preferably selected from the class of polyethylene (PE) (C₂H₄)ₙH₂, which has a crystalline structure that is translucent and which advantageously allows for the uniform distribution of color pigments prior to curing. The light cover 12 is preferably globular in shape which would better resist and distribute imparted force than other shapes, and has a stem 18 that is dimensioned for press-fit engagement into the receptacle 16. The stem 18 has a neck portion 15 and a cylindrical wall section (as shown in FIGS. 2 and 4) extending from the light cover 12 and an opening dimensioned for receiving the LED 14. The neck portion 15 preferably has a radial diameter smaller than a radial diameter of the cylindrical wall section of the stem. Advantageously, the receptacle 16 preferably includes a seal 20 which may be configured as one or more compliant or elastic annular protrusions or projections along the inside circumferential wall of collar 13 forming the cylindrical opening of the receptacle 16 for press-fit engagement with the neck portion 15 of the stem 14 of the light cover 12. Once engaged with the neck portion 15 of the stem 18 and the annular projection snaps into position around the neck portion 15, water will not be able to drip or seep through the receptacle opening, i.e. between the seal 20 and the neck portion 15 of stem 18. Although not shown, it is contemplated that one or more additional annular seals 20 may be optionally or additionally formed along the outside circumferential wall of the cylindrical section of stem 18 for sealing engagement with the inside wall of collar 13 for additional sealing protection of the LED 14 and electrical connections within the light assembly 10. The receptacle 16 is configured to receive and secure the LED 14 onto seat 17, which includes conduits or pathways for the anode 22 and cathode 24 of the LED 14 to pass through and make electrical connection with power leads 32 in the holder 30. Once the LED 14 is seated on the seat 17 in the receptacle 16, the anode 22 and cathode 24 of the LED 14 may be bent outwardly and along the respective cathode and anode seating portions 23, 25 of the receptacle 16 to thereby secure the LED 14 in the receptacle 16. The cathode and anode seating portions 23, 25 electrically isolate the anode 22 and cathode 24 and are formed along the longitudinal section of seat 17 of the receptacle 26. The cathode and anode seating portions 23, 25 are shaped and dimensioned for enabling the anode 22 and cathode 24 to engage conductive contacts or pads 36 disposed on the inner wall of the holder 30. The conductive pads 36 are preferably disposed on diametrically opposing surfaces of the inner cylindrical wall of holder 30 for electrical contact engagement with the anode 22 and cathode 24 of the LED 14. The conductive contacts 36 are connected to electrical leads 32, which, in turn, are connected to a power source. The receptacle 16 also includes a flexible retainer tab 26 extending from the collar 13 for removable locking engagement with a corresponding clip 28 of holder 30. The clip 28 is elastic and shaped to interlock with the retainer tab 26, so as to maintain the receptacle in the cavity of holder 30. The inner cylindrical wall of holder 30 is dimensioned and configured for press-fit engagement with the collar 13 of the receptacle 16 to form a water resistant interface with the outside wall 16. The holder 30 includes a retainer 34 for securing conductive contacts or pads 36 of electrical leads 32.

FIG. 2 is a cutaway view of an embodiment of the light assembly 10. As shown, the light cover 12 has a cavity defined by a globular wall and the stem 18 having a cylindrical section extending from the globular wall for receiving the LED 14 and for press-fit engagement with receptacle 16. The receptacle 16 has a seal 20 which may be constructed of one or more annular protrusions or projections around the inside opening of the receptacle 16. The receptacle 16 includes a seat 17 for the LED 14 to rest on with the anode 22 and cathode 24 straddling along both sides of the seat 17. Retainer tab 26 extends from the receptacle 16 and is bendable for locking engagement with the corresponding clip 28. Holder 30 includes a chamber dimensioned for press-fit engagement with the collar 16 of receptacle 16 for keeping water out of the chamber. The holder 30 has a retainer 34 configured for attachment of conductive contacts connected to leads 32. The leads 32 provide for electrical connection with the power source and for connecting multiple LEDs along a strand in a parallel circuit such that malfunction of a single light assembly does not cause the entire strand of LEDs to malfunction.

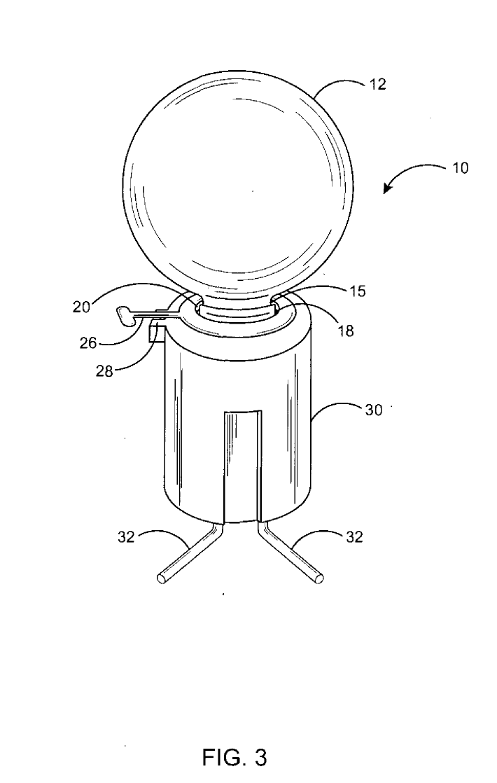

As shown in FIG. 3, the light assembly 10 is assembled by inserting the receptacle 16 with its LED 14 into holder 30 in a press-fit engagement. The light cover 12 is then attached to the receptacle 16 by inserting the stem 18 into receptacle 16 and the annular protrusion 20 snaps onto the neck portion 15 of the stem 18.

As shown in FIG. 4, when assembled, the neck portion 13 of stem 18 of light cover 12 is snapped into engagement with the annular protrusion 20 of receptacle 16. Advantageously, the neck portion 13 and the annular protrusion 20 form a sealing and interlocking interface. In this manner, the light assembly 10 is water-resistant and the light cover 12 is removably secured by the receptacle 16. The light cover 12 may be easily removed from the receptacle 16 by simply pulling the light cover 12 away from the receptacle 16 causing the neck portion 13 of the light cover 12 to unseat from the annular protrusion 20. An advantage of this light assembly 10 is that the light cover 12 is dimensioned for ease of manual manipulation so that the light covers can be easily removed and interchanged with different colored light covers.

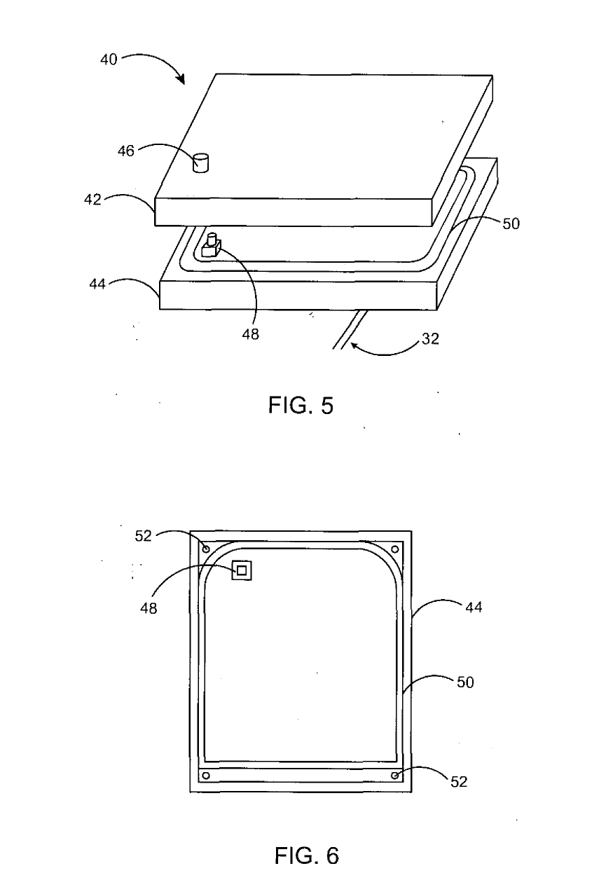

FIG. 5 shows a battery pack 40 having a top portion 42 and bottom portion 44 with water resistant features including a flexible switch cover 46 protruding from the top portion 42 through an opening. The switch cover 46 is preferably constructed of rubber for enclosing an ON/OFF switch 48 located at the bottom portion 44. The bottom portion 44 also includes a compressible edge seal 50 along its edges for sealing engagement with the top portion 42. Leads 32 extend from the bottom portion of the battery pack 40 for electrical connection with the LEDs 14 of light assembly 10. An advantage of this battery pack 40 in combination with the light assembly 10 is that this combined battery pack and light assembly can be placed in any desired location without being limited or encumbered by the proximity of an A/C outlet or the tangled length of an A/C power cord.

FIG. 6 is a plan view of the bottom portion 44 of the battery pack 40 showing the ON/OFF switch 48 and the edge seal 50. Mounting holes 52 for receiving screws may also be provided for attaching the top and bottom portions 42, 44 and for compressing the edge seal 50 to achieve effective water resistant seal 50.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A decorative light assembly, comprises:
a receptacle having a circumferential wall forming a receptacle opening and a longitudinal seat portion configured to retain a Light Emitting Diode (LED), the circumferential wall having an annular protrusion, the longitudinal seat portion having a first and a second conduits, each of the first and second conduits being dimensioned for receiving a cathode and an anode of the LED, respectively;
a light cover having a cavity, the light cover having a stem configured to receive the LED into the cavity of the light cover and to extend from the light cover and into the receptacle opening of the receptacle, the stem having a neck portion configured to form a water resistant seal with and retention by the annular protrusion on the circumferential wall of the receptacle and a cylindrical section dimensioned for press-fit engagement with the circumferential wall of the receptacle, the neck portion having a radial diameter smaller than a radial diameter of the cylindrical section of the stem; and
a holder having an inner wall forming an opening and a chamber, the holder providing electrical connections to a power source, the chamber being configured for receiving and securing the receptacle for electrical connection between the power source and the cathode and anode of the LED, the inner wall of the holder being dimensioned for press-fit engagement with an outside surface of the circumferential wall of the receptacle.

2. The decorative light assembly of claim 1, wherein the light cover is globular.

3. The decorative light assembly of claim 1, wherein the light cover is made from a class of polyethylene (PE) (C₂H₄)ₙH₂.

4. The decorative light assembly of claim 1, wherein the circumferential wall of the receptacle includes an additional annular protrusion for sealing engagement with the stem of the light cover.

5. The decorative light assembly of claim 1, wherein the cylindrical section of the stem of the light cover includes an annular protrusion for sealing engagement with the circumferential wall of the receptacle.

6. The decorative assembly of claim 1, further comprising the LED retained in the receptacle.

7. The decorative assembly of claim 1, wherein the receptacle includes a flexible retainer extending from the circumferential wall of the receptacle, and the holder includes a clip configured for removable locking attachment with the flexible retainer so as to retain the receptacle in the chamber of the holder.

8. A portable water-resistant decorative light string, comprising:
two or more Light Emitting Diode s(LED), each LED having a cathode and an anode;
a receptacle having a circumferential wall forming a receptacle opening and a longitudinal seat portion configured to retain one of the two or more LEDs, the longitudinal seat portion having a first and a second conduits, each of the first and second conduits being dimensioned for receiving the cathode and the anode of the one of the two or more LEDs, respectively;
a light cover having a cavity, the light cover having a stem configured to receive the LED into the cavity of the light cover and to extend from the light cover and into the receptacle opening of the receptacle to form a water resistant seal with the circumferential wall of the receptacle;
a holder having an inner wall forming an opening and a chamber, the holder providing electrical connections to a power source, the chamber being configured for receiving and securing the receptacle for electrical connection between the power source and the cathode and anode of the one of the two or more LEDs, the inner wall of the holder being dimensioned for press-fit engagement with an outside surface of the circumferential wall of the receptacle; and
a direct current (D/C) battery pack connected to the cathodes and anodes of the two or more LEDs.

9. The portable water-resistant decorative light string of claim 8, wherein the cathodes and anodes of the two or more LEDs are connected in a parallel circuit with the battery pack.

10. The portable water-resistant decorative light string of claim 8, wherein the battery pack includes a top portion and a bottom portion, the top and bottom portions defining a chamber for retaining one or more batteries, and a seal between the top and bottom portions for water resistant sealing engagement with the top and bottom portions upon attachment of the top and bottom portions.

11. The portable water-resistant decorative light string of claim 10, wherein the battery pack includes a user-activated On/Off Switch disposed on the bottom portion for switching electrical current from the one or more batteries to the LEDs between an On and Off position, and a water-resistant sealing cover protruding from an opening in the top portion, the water-resistant sealing cover being positioned and configured to receive a portion of the user-activated On/Off Switch and to prevent water from entering into the chamber defined by the top and bottom portions through the opening in the top portion.

12. The portable water-resistant decorative light string of claim 8, wherein the light cover is globular.

13. The portable water-resistant decorative light string of claim 8, wherein the light cover is made from a class of polyethylene (PE) (C₂H₄)ₙH₂.

14. The portable water-resistant decorative light string of claim 8, wherein the circumferential wall of the receptacle includes an annular protrusion, and the stem of the light cover has a neck portion configured to form a water resistant seal with and for retention by the annular protrusion on the circumferential wall of the receptacle, the stem having a cylindrical section dimensioned for press-fit engagement with the circumferential wall of the receptacle, the neck portion having a radial diameter smaller than a radial diameter of the cylindrical section of the stem.

15. The portable water-resistant decorative light string of claim 8, wherein the stem of the light cover includes an annular protrusion for sealing engagement with the circumferential wall of the receptacle.

16. The portable water-resistant decorative light string of claim 8, wherein the receptacle includes a flexible retainer extending from the circumferential wall of the receptacle, and the holder includes a clip configured for removable locking attachment with the flexible retainer so as to retain the receptacle in the chamber of the holder.

17. A light holder assembly, comprising:
a cylindrical receptacle having a circumferential wall forming a receptacle opening and a longitudinal seat portion configured to retain a Light Emitting Diode (LED), the longitudinal seat portion having a first and a second conduits, each of the first and second conduits being dimensioned for feeding a cathode lead wire and an anode lead wire of the LED through said first and second conduits, respectively, each of the cathode lead wire and the anode lead wire being bent upwardly against the longitudinal seat portion in a retained position;
a globular light cover having a cavity, the globular light cover having a stem having a cylindrical section configured to receive the LED into the cavity of the light cover and to extend from the globular light cover and into the receptacle opening of the cylindrical receptacle to form a water resistant seal with the circumferential wall of the receptacle; and
a cylindrical holder having an inner wall forming an open chamber, the cylindrical holder including electrical power leads to a power source, the chamber being configured for receiving and securing the receptacle for electrical connection between the electrical power leads and the cathode and anode leads of the LED, the inner wall of the cylindrical holder being dimensioned for press-fit engagement with an outside surface of the circumferential wall of the receptacle.

18. The light holder assembly of claim 17, wherein the stem has a neck portion having a radial diameter smaller than a radial diameter of the cylindrical section, and the circumferential wall of the receptacle includes an elastic annular protrusion for sealing engagement with the neck portion of the stem of the globular light cover.

19. The light holder assembly of claim 18, wherein the cylindrical section of the stem or the circumferential wall of the receptacle includes an additional annular protrusion.

20. The light holder assembly of claim 18, further comprising the LED retained in the receptacle.
